(19) United States
(12) Patent Application Publication
(10) Pub. No.: US 2012/0075223 A1
(43) Pub. Date: Mar. 29, 2012

(54) MOBILE ELECTRIC DEVICE

(75) Inventor: Reiko YAMASHITA, Anpachi-cho (JP)

(73) Assignee: Kyocera Corporation, Kyoto (JP)

(21) Appl. No.: 13/247,957

(22) Filed: Sep. 28, 2011

(30) Foreign Application Priority Data
Sep. 28, 2010 (JP) 2010-217854

(51) Int. Cl. G06F 3/041

(52) U.S. Cl. 345/173

(57) ABSTRACT

An electronic display control device and method are disclosed. A web page comprising a plurality of links is displayed on display screen of a touch panel, and an operation is detected on the touch panel. The links are collectively displayed on a region of the display screen, when the prescribed operation is detected while the web page is displayed on the touch panel.

### CROSS-REFERENCE TO RELATED APPLICATION

The present application claims priority under 35 U.S.C. §119 to Japanese Patent Application No. 2010-217854, filed on Sep. 28, 2010, entitled “MOBILE ELECTRONIC DEVICE AND METHOD FOR CONTROLLING DISPLAY ON MOBILE ELECTRONIC DEVICE”. The content of which is incorporated by reference herein in its entirety.

### FIELD

Embodiments of the present disclosure relate generally to mobile electronic devices, and more particularly relate to a mobile electronic device comprising a touch panel thereon.

### BACKGROUND

Mobile electronic devices such as mobile phones, PDA (Personal Digital Assistant), or the like comprise a display that comprises a touch panel. Such a mobile electronic device is capable of displaying a web page that comprises links on a touch panel. A user is able to select a link by touching the location at which the link is displayed. However, the location at which the link is displayed varies depending on the web page. Consequently, it may be not easy for the user to determine which part of the web page is a link. If the size of a display module provided with a mobile electronic device increases, links may be displayed over a wide range. If the links are displayed over a wide range, it may be more difficult for the user to determine the location of the links.

### SUMMARY

An electronic display control device and method are disclosed. A web page comprising a plurality of links is displayed on a display screen of a touch panel, and an operation is detected on the touch panel. The links are collectively displayed on a region of the display screen, when the prescribed operation is detected while the web page is displayed on the touch panel.

Consequently, determining which part of the web page is a link is substantially easy for the user. Especially, if a size of a display screen provided with a mobile electronic device increases where links may be displayed over a wide range, determining the location of the links is substantially easy for the user.

In an embodiment, an electronic device comprises a touch panel an operation detection module, and a control module. The touch panel comprises a display screen operable to display a first web page comprising a first plurality of links. The operation detection module is operable to detect an operation by a user. The control module is operable to display the first links in a first region of the display screen as a first collective link display, when the operation is detected.

In another embodiment, an electronic device display control method displays a web page comprising a plurality of links on a touch panel, and detects an operation on the touch panel. The method further collectively displays the links on a region of a display screen, when the operation is detected while the web page is displayed on the touch panel.

### BRIEF DESCRIPTION OF THE DRAWING

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of a perspective view of a mobile phone according to an embodiment of the disclosure.

FIG. 2 is an illustration of an exemplary functional block diagram of a mobile phone according to an embodiment of the disclosure.

FIG. 3 is an illustration of an exemplary functional block diagram of a mobile phone according to an embodiment of the disclosure.

FIG. 4 is an illustration of a display example of data that is displayed on a touch panel according to an embodiment of the disclosure.

FIG. 5 is an illustration of a display example of data that is displayed on a touch panel according to an embodiment of the disclosure.

FIG. 6 is an illustration of a flow diagram of a display control processing according to an embodiment of the disclosure.

FIG. 7 is an illustration of a display example of data that is displayed on a touch panel according to an embodiment of the disclosure.

FIG. 8 shows how a user may hold a mobile phone in her/his right hand.

FIG. 9 shows how a user may hold a mobile phone in her/his right hand.

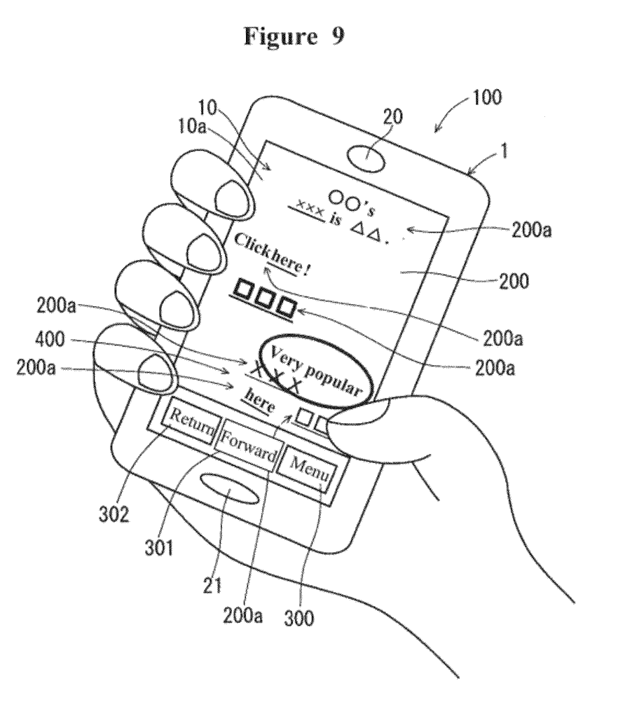

FIG. 10 is an illustration of a display example of data that is displayed on a touch panel according to an embodiment of the disclosure.

FIG. 11 is an illustration of a display example of data that is displayed on a touch panel according to an embodiment of the disclosure.

FIG. 12 is an illustration of a display example of data that is displayed on a touch panel according to an embodiment of the disclosure.

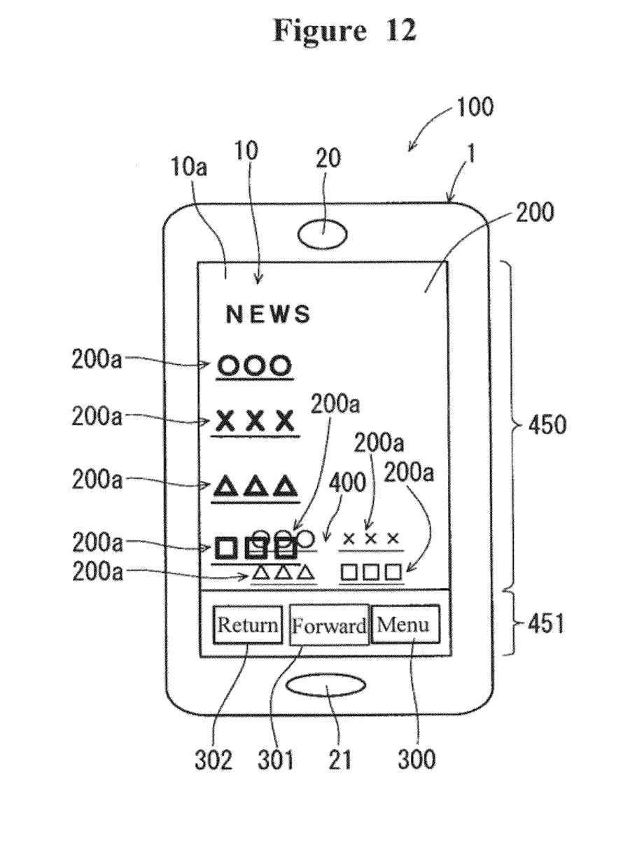

FIG. 13 is an illustration of a display example of data that is displayed on a touch panel according to an embodiment of the disclosure.

FIG. 14 is an illustration of a display example of data that is displayed on a touch panel according to an embodiment of the disclosure.

FIG. 15 is an illustration of a display example of data that is displayed on a touch panel according to an embodiment of the disclosure.

FIG. 16 is an illustration of a display example of data that is displayed on a touch panel according to an embodiment of the disclosure.

FIG. 17 is an illustration of a display example of data that is displayed on a touch panel according to an embodiment of the disclosure.

FIG. 18 is an illustration of a display example of data that is displayed on a touch panel according to an embodiment of the disclosure.

FIG. 19 is an illustration of a display example of data that is displayed on a touch panel according to an embodiment of the disclosure.

FIG. 20 is an illustration of a display example of data that is displayed on a touch panel according to an embodiment of the disclosure.

FIG. 21 is an illustration of a display example of data that is displayed on a touch panel according to an embodiment of the disclosure.

FIG. 22 shows how a display screen is operated by a user's finger according to an embodiment of the disclosure.

FIG. 23 shows how a display screen is operated by a user's finger according to an embodiment of the disclosure.

FIG. 24 is an illustration of a display example of data that is displayed on a touch panel according to an embodiment of the disclosure.

FIG. 25 is an illustration of a display example of data that is displayed on a touch panel according to an embodiment of the disclosure.

FIG. 26 shows how a display screen is operated by a user's finger according to an embodiment of the disclosure.

FIG. 27 is an illustration of a display example of data that is displayed on a touch panel according to an embodiment of the disclosure.

FIG. 28 is an illustration of a display example of data that is displayed on a touch panel according to an embodiment of the disclosure.

FIG. 29 is an illustration of a display example of data that is displayed on a touch panel according to an embodiment of the disclosure.

FIG. 30 is an illustration of a display example of data that is displayed on a touch panel according to an embodiment of the disclosure.

FIG. 31 is an illustration of a display example of data that is displayed on a touch panel according to an embodiment of the disclosure.

FIG. 32 is an illustration of a display example of data that is displayed on a touch panel according to an embodiment of the disclosure.

FIG. 33 is an illustration of a display example of data that is displayed on a touch panel according to an embodiment of the disclosure.

FIG. 34 is an illustration of a display example of data that is displayed on a touch panel according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, GPS's or navigation systems, pedometers, health equipments, display monitors, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

A mobile phone 100 comprises a case body 1 with a substantially rectangular plate shape when seen from a plane view. The case body 1 may comprise a display module 10 that has a touch panel 10a. The display module 10 is of a rectangular shape. The touch panel 10a is exposed on one of the main surfaces of the case body 1. The user is able to input data and give various commands by touching the touch panel 10a with a finger, pen, or the like.

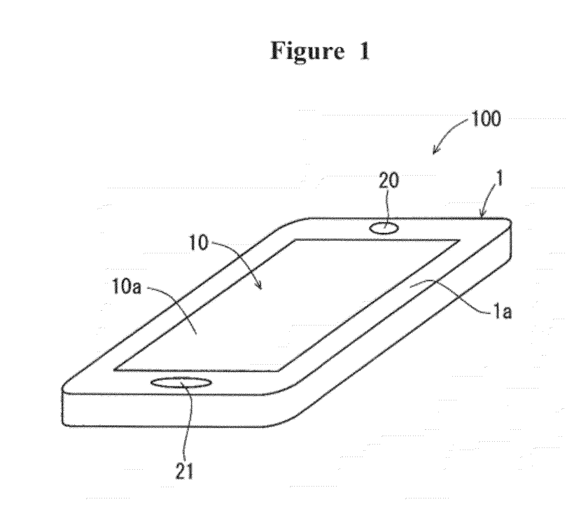

FIG. 1 is an illustration of a perspective view of a mobile phone according to an embodiment of the disclosure. The case body 1 may comprise a voice output module 20 as well as a voice input module 21. The voice output module 20 comprises a speaker and the voice input module 21 comprises a microphone. The voice output module 20 is located at the upper end of the main surface 1a of the case body 1. The voice input module 21 is located at the lower end of the main surface 1a.

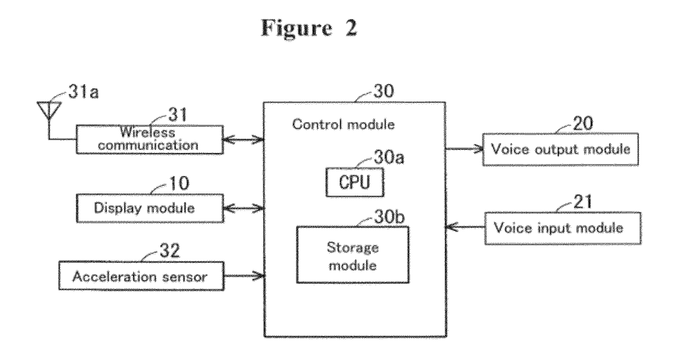

FIG. 2 is an illustration of an exemplary functional block diagram of a mobile phone 100 according to an embodiment of the disclosure.

The mobile phone 100 comprises a control module 30, a wireless communication module 31, an acceleration sensor 32, the display module 10, the voice output module 20, and the voice input module 21. The case body 1 houses the control module 30, wireless communication module 31, and the acceleration sensor 32 therein.

The control module 30 comprises a CPU 30a and a storage module 30b. The control module 30 is capable of comprehensively managing an operation of the mobile phone 100 by controlling component elements of the mobile phone 100.

The storage module 30b may comprise a ROM, RAM, and the like. The CPU 30a executes a variety of programs within the storage module 30b to realize various functions of the control module 30.

The wireless communication module 31 receives, via an antenna 31a, signals from an electronic device that is different from the mobile phone 100 or from a communication device connected to the internet such as a web server, or the like. The wireless communication module 31 conducts amplification or down-conversion processing with respect to the received signals. The wireless communication module 31 outputs the received signals that have been subjected to processing at the control module 30. The wireless communication module 31 conducts up-conversion or amplification processing with respect to the transmission signals that have been generated at the control module 30. The wireless communication module 31 wirelessly transmits the processed transmission signals to an electronic device that is different from the mobile phone 100 or to a communication device connected to the internet via the antenna 31a.

A triaxial acceleration sensor can serve as the acceleration sensor 32. In this case, the acceleration sensor 32 detects the acceleration speed in a respective direction along three mutually perpendicular detection shafts. The acceleration sensor 32 outputs the detected acceleration speed to the control module 30. The acceleration sensor 32 detects the acceleration speed at every preliminarily determined interval and outputs said acceleration speed to the control module 30. The preliminarily determined interval may be set to be, for example but without limitation, about 1 msec.

The voice output module 20 is capable of converting voice data output from the control module 30 to voices. The voice output module 20 is capable of outputting voices. The voice input module 21 is capable of converting voices input from outside into voice data. The voice output module 20 is capable of outputting the voice data to the control module 30.

The display module 10 is capable of displaying a variety of information such as letters, symbols, graphics, or the like via the control module 30. The display module 10 is capable of detecting user operations with using the touch panel 10a. The display module 10 outputs, to the control module 30, an operation signal according to the detected operation of the user. The display module 10 may comprise a transparent liquid crystal display panel and a back light-light source to emit light from the back to the liquid crystal display panel. Non-self-luminous display panels other than the display module 10 and liquid crystal display panel as well as self-luminous display panels such as organic EL panels, or the like, may also be used.

The user can input a variety of information into the mobile phone 100 by operating the touch panel 10a of the display module 10. The display module 10 can detect a location on the touch panel 10a touched by the user. The display module 10 can detect the location on the touch panel 10a touched by the user at prescribed intervals. The display module 10 can detect that the user has moved their finger away from the touch panel 10a. The prescribed interval is, for example but without limitation, about 5 msec, and a similar value. The display module 10 outputs, to the control module 30, the location on the touch panel 10a touched by the user as an operation signal. The user can touch the touch panel 10a with a part of her/his body besides a finger.

A display screen for displaying a variety of information on the display module 10 is different from the touch panel 10a. In this case, the display module 10 displays a variety of information on the display screen such as a display, or the like, and the touch panel 10a is provided so as to overlap the display screen. An embodiment describes the touch panel 10a which comprises a touch panel for detecting user operations and the display screen overlapped thereto for displaying the variety of information.

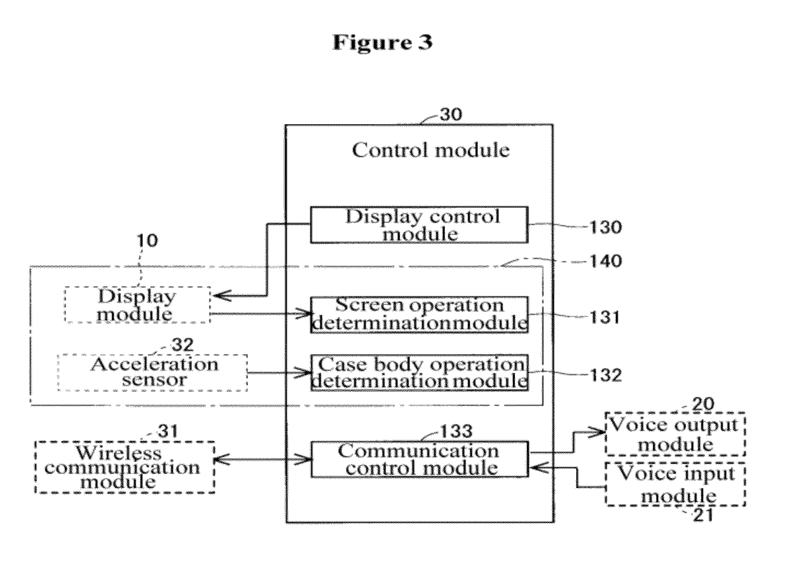

FIG. 3 is an illustration of an exemplary functional block diagram of the mobile phone 100 according to an embodiment of the disclosure.

The CPU 30a of the control module 30 executes a variety of programs within the storage module 30b so as to be formed within the control module 30. The control module 30 comprises a display control module 130, screen operation-determination module 131, case body operation-determination module 132, and communication control module 133. In an embodiment, an operation detection module 140 comprises a display module 10, screen operation-determination module 131, acceleration sensor 32, and case body operation-determination module 132. The operation detection module 140 detects user operations with respect to the mobile phone 100. The screen operation-determination module 131 determines a content of detected user operations. The case body operation-determination module 132 determines the content of user operations, based on output signals from the acceleration sensor 32.

The display control module 130 controls the display of the display module 10. The display module 10 displays information such as letters, or the like on the touch panel 10a via control by the display control module 130.

The screen operation-determination module 131 determines the content of user operations, based on operation signals output by the display module 10. For example, the screen operation-determination module 131 determines that a user operation is an operation to press a section of the touch panel 10a with a finger or determines that an operation is to move from one section to another section while a finger is still in contact with the touch panel 10a.

The display control module 130 is capable of controlling the display of the display module 10 based on the content of the operation that is determined by the screen operation-determination module 131. If the location of a finger detected at every prescribed interval by the display module 10 changes, the screen operation-determination module 131 determines that the finger is moving. If the location of the finger does not change from a time when the location of the finger is detected by the display module 10 until the location of the finger is no longer detected, the screen operation-determination module 131 determines that it is an operation to press a section on the touch panel 10a with a finger.

The case body operation-determination module 132 determines the content of user operations with respect to the case body 1 of the mobile phone 100, based on the output signals from the acceleration sensor 32. For example, the case body operation-determination module 132 determines whether the mobile phone 100 is being shaken by the user or is inclining from a standard position, or the like, based on the output signals from the acceleration sensor 32. The display control module 130 is capable of controlling the display of the display module 10 based on the content of the operation that is determined by the case body operation-determination module 132. If there is no change in the output signals from the acceleration sensor 32, the case body operation-determination module 132 determines that the mobile phone 100 is still.

If it is determined that the mobile phone is still, the case body operation-determination module 132 determines the inclination from the standard position based on the output signal from the acceleration sensor 32. If there are any changes in the output signals from the acceleration sensor 32, the case body operation-determination module 132 determines that the mobile phone 100 is being shaken by the user. The case body operation-determination module 132 determines the moving direction of the mobile phone 100 based on changes in the output signals from the acceleration sensor 32. The screen operation-determination module 132 of the mobile phone 100 determines the moving speed of a finger from the position of the finger detected at each prescribed interval.

The communication control module 133 causes the wireless communication module 31 to communicate with a communicating counterpart. For example, the communication control module 133 conducts voice communications or e-mail communications with a mobile phone of the communicating counterpart. In the event of voice communications, the communication control module 133 generates transmission signals including the voice data input from the voice input module 21. The communication control module 133 transmits the transmission signals to the mobile phone of the communicating counterpart via the wireless communication module 31. The communication control module 133 acquires the voice data from the signals received by the wireless communication module 31 and outputs the voice data to the voice output module 20.

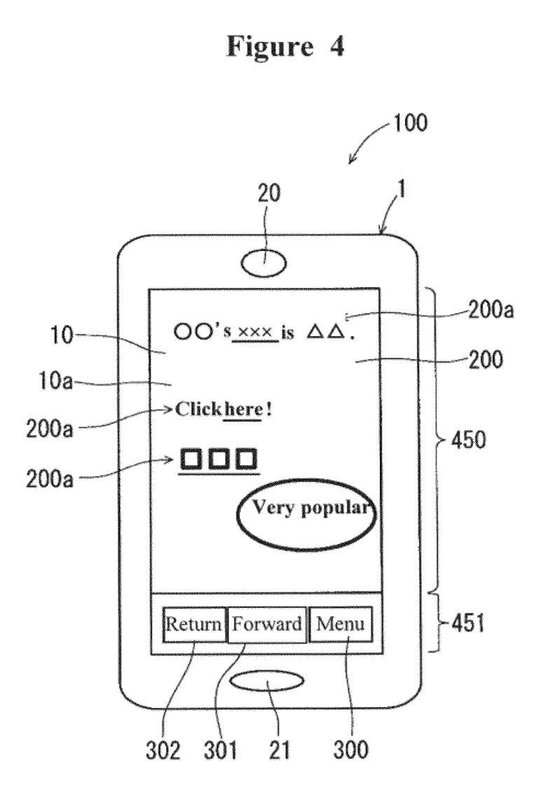

When a web browser within the storage module 30b is brought up by the CPU 30a, the communication control module 133 conducts data communication with the web server. A web page received from the web server is displayed on the touch panel 10a. FIG. 4 shows one example of a web page 200 on the touch panel 10a. The web browser may comprise, for example but without limitation, a software for browsing a PC site which is a website designed for personal computers, software for browsing a mobile site which is a website designed for mobile electronic devices such as a mobile phone, software for browsing both a PC site and a mobile site, or other web browser.

The touch panel 10a comprises a first region 450 and a second region 451. The web page 200 is displayed in the first region 450. A plurality of operation buttons 300 to 302 are displayed on the second region 451. Hereinafter, the first region 450 is referred to as a “web display region 450.”

An operation button 300 is an operation button for displaying a menu screen. An operation button 301 indicated by “forward” is a web page displayed in the past, and displays a web page that is displayed one after the currently displayed web page. An operation button 302 indicated by “return” is a web page displayed one before the currently displayed web page. The user is able to select each of operation buttons 300 to 302 by tapping (an operation to remove (within a prescribed interval) a finger from the touch panel 10a immediately after touching the touch panel with the finger). It is not necessarily required for the user to use a finger for tapping, and any part of the user's body may be used besides fingers.

A plurality of links 200a shown in FIG. 4 is comprised in the web page 200. The user is able to select a link 200a by tapping the region where the links 200a are displayed (hereinafter, referred to as the “link display region”). If the operation detection module 140 detects that a selection operation for selecting the link 200a is carried out, the communication control module 133 acquires the web page 200 indicated by the selected link 200a from a web server via the wireless communication module 31. The acquired web page 200 is displayed on the touch panel 10a by the display control module 130. In FIG. 4, the link 200a in the web page 200 is indicated by an underline. The link 200a is also referred to as a “hyper link.”

In general, each web page 200 shows a link 200a in a proprietary location. The location at which the link 200a is shown varies for each web page 200. Consequently, the user may find it difficult to determine which module of each web page 200 is a link.

When a prescribed operation with respect to the mobile phone 100 is detected by the operation detection module 140, the display module 10 collectively displays the plurality of links 200a included on the web page 200 in a third region 400. Consequently, it becomes easier for the user to select each link 200a.

An operation for gathering and displaying the plurality of links 200a is referred to as a “collective link display.” A web page display, shown in FIG. 4, on which no collective link display is executed is referred to as a “normal display.” An operation for the user to command the collective link display with respect to the mobile phone 100 is referred to as a “collective display-command operation.” The plurality of links 200a gathered in the third region 400 is referred to as a “collective link.” The third region 400 is referred to as a “collective link-display region 400.”

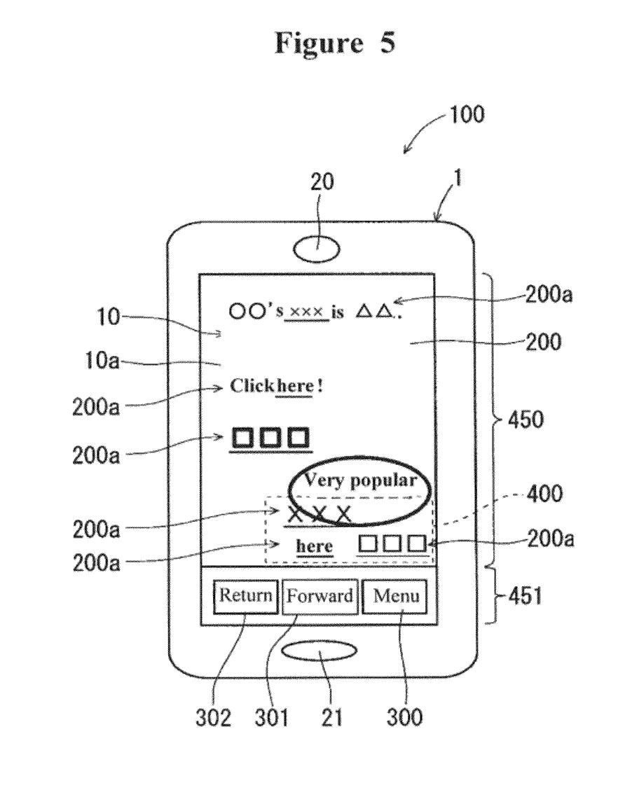

In FIG. 5, the collective link is displayed in an overlaid manner so as to be overlapped with the web page 200. Letters, or the like, shown in the web page 200 are indicated by a bold line and the collective link is displayed by a narrow line. Consequently, the display module 10 is capable of displaying such that the display density of the collective link becomes lower than that of the web page 200. The user is able to see through a section that is overlapped with the collective link in the web page 200 from the collective link.

Two-thirds of the region on the lower right of a web display region 450 of the touch panel 10a (right side when the mobile phone 100 is seen from the touch panel 10a side) is the collective link-display region 400. Therefore, the collective link is moved to the right of the touch panel 10a when displayed.

Next, operations of the mobile phone 100 when the mobile phone 100 executes a collective link display are described.

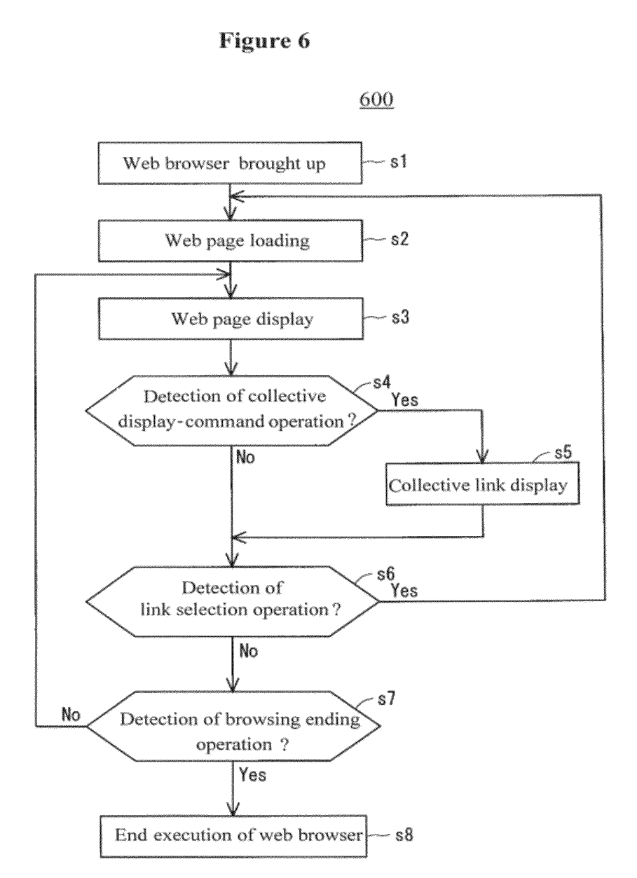

FIG. 6 is an illustration of a flow diagram of the display control processing according to an embodiment of the disclosure. The various tasks performed in connection with process 600 may be performed, by software, hardware, firmware, a computer-readable medium having computer executable instructions for performing the process method, or any combination thereof. The process 600 may be recorded in a computer-readable medium such as a semiconductor memory, a magnetic disk, an optical disk, and the like, and can be accessed and executed, for example, by a computer CPU such as the CPU 30a in which the computer-readable medium is stored. It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein

A process 600 starts when the CPU 30a executes the web browser within the storage module 30b (task s1). At task s2, the communication control module 133 receives a web page from the web server via the wireless communication module 31. At task s3, the display module 10 normally displays the web page comprising a plurality of links received at task s2 on a display screen of the touch panel 10a.

When the operation detection module 140 detects a collective display-command operation with respect to the mobile phone 100 (“Yes”, branch of inquiry task s4), the display module 10 executes the collective link display (task s5). In this manner, the display screen collectively displays the links on a region of the display screen, when the operation is detected while the web page is displayed on the touch panel 10a.

In an embodiment, two kinds of collective display-command operations are defined in the mobile phone 100. The first collective display-command operation comprises an operation to briskly shake the mobile phone 100 downwards when the mobile phone 100 is in a state inclining to the right thereof when seen from the touch panel 10a side. The second collective display-command operation is an operation to briskly shake the mobile phone 100 downwards when said mobile phone 100 is in a state inclining to the left thereof when seen from the touch panel 10a side. The case body operation-determination module 132 is capable of determining the inclining direction of the mobile phone 100 or direction in which the mobile phone 100 is briskly being shaken, based on the output signal from the acceleration sensor 32.

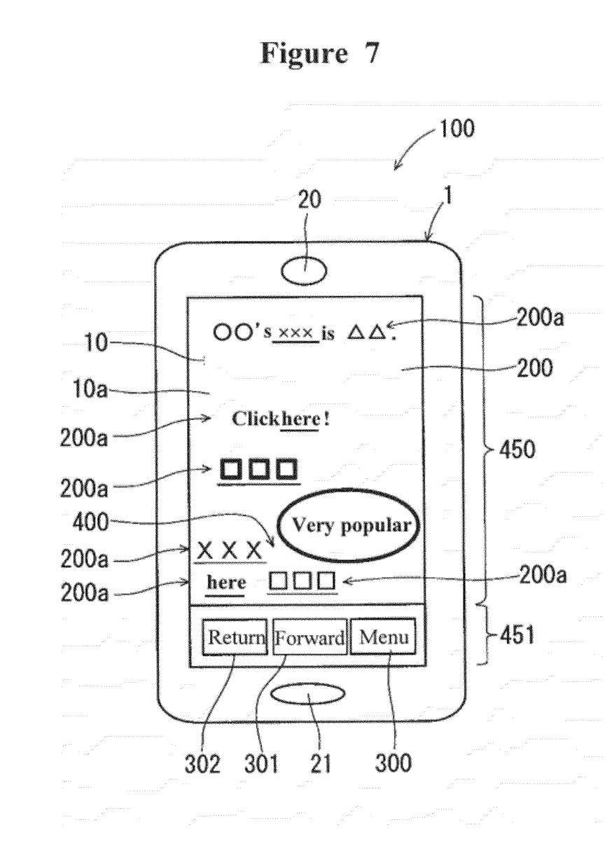

When either of the first or second collective display-command operations is detected at the operation detection module 140, the display module 10 gathers the plurality of links 200a and displays said plurality of links 200a on the touch panel 10a. When the operation detection module 140 detects the first collective display-command operation, the plurality of links 200a are moved to the lower right of the web display region 450 and displayed therein as shown in FIG. 5. When the operation detection module 140 detects the second collective display-command operation, the plurality of links 200a are moved to the lower left of the web display region 450 and displayed therein as shown in FIG. 7. In this case, two-thirds of the region on the lower left of the web display region 450 is the collective link-display region 400.

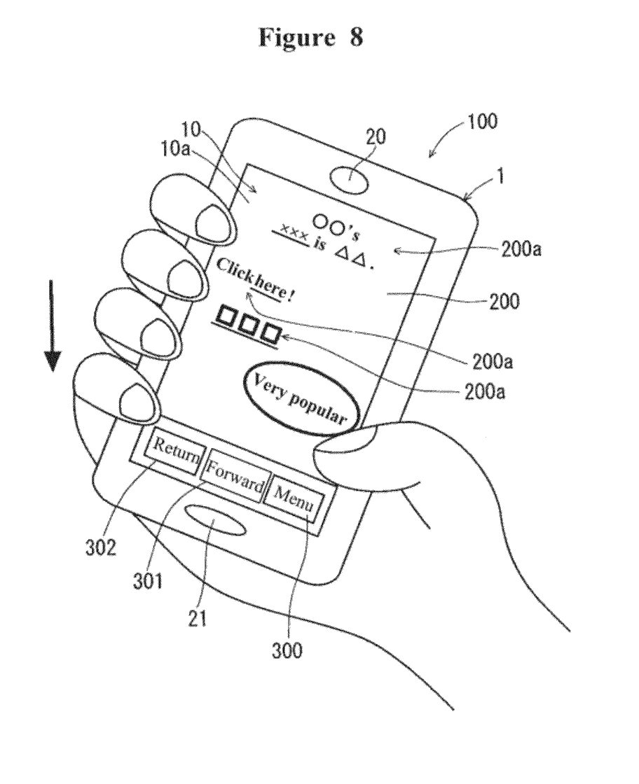

As described above, if the mobile phone 100 is shaken briskly downwards when said mobile phone 100 is in an inclining state to the right, the plurality of links 200a displayed on the touch panel 10a are moved to the right and displayed on the touch panel 10a. As shown in FIG. 8, while looking at the touch panel 10a, if the user holding the mobile phone 100 in her/his right hand briskly shakes the mobile phone 100 downwards when the mobile phone is in an inclining state to the right, the plurality of links 200a are moved to the right and displayed on the touch panel 10a. Consequently, it becomes easy for the user to select the link 200a with the thumb of the right hand that is holding the mobile phone 100.

If the mobile phone 100 is briskly shaken downwards when said mobile phone 100 is in an inclining state to the left, the plurality of links 200a displayed on the touch panel 10a are moved to the left and displayed on the touch panel 10a. Therefore, while looking at the touch panel 10a, if the user holding the mobile phone 100 in her/his right hand briskly shakes the mobile phone 100 downwards when the mobile phone is in an inclined state to the left, the plurality of links 200a are moved to the left and displayed on the touch panel 10a. Consequently, it becomes easy for the user to select the link 200a with the thumb of the left hand that is holding the mobile phone 100.

The user may also scroll the display of the web page 200 by carrying out a prescribed operation (second additional operation) with respect to the collective link-display region 400. If the operation detection module 140 detects a prescribed operation with respect to the collective link-display region 400, the display module 10 scrolls the display of the web page 200 on the touch panel 10a. For example, if the operation detection module 140 detects a flick (an operation of flicking a finger at a speed faster than a prescribed speed) upwards with respect to the collective link-display region 400, the display module 10 upwardly scrolls the display of the web page 200. If the operation detection module 140 detects a flick downwards with respect to the collective link-display region 400, the display module 10 downwardly scrolls the display of the web page 200.

As described above, the user is able to conduct, with respect to the touch panel 10a, an operation to select the link 200a and an operation to command scrolling at a close place or at the same place. Operations with respect to the touch panel 10a may become easy for the user.

Also, by flicking a region other than the collective link-display region 400 in the web display region 450, the user is likewise able to scroll the display of the web page 200 on the touch panel 10a.

When the operation detection module 140 detects a selection operation for selecting one of the plurality of links 200a (task s6), at task s2, a web page displayed by the selected link 200a is received from the web server in the communication control module 133. Then, at task s3, the web page received by the communication control module 133 is brought to a normal display by the display module 10. The selection operation comprises an operation to select one of the plurality of links 200a by the user tapping the link display region.

If the web page 200 is in normal display, the user is able to select one of the plurality of links 200a. If the collective link display is being displayed, the user may select one of the plurality of links 200a shown in the web page 200 or select one of the plurality of 200a shown in the collective link-display region 400. In an event of selecting a link 200a that is being displayed in the collective link-display region 400, the user taps the link display region with regard to the link 200a to be selected as in the case of selecting a link 200a that is being displayed on the web page 200.

When the operation detection module 140 detects a command to end browsing of the web page (task s7), the CPU 30a terminates the bringing up of the web browser at task s8.

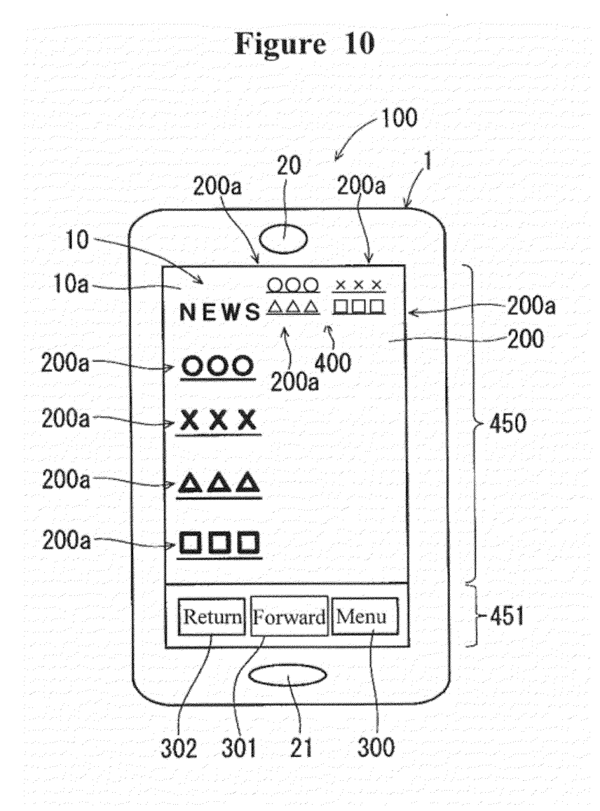

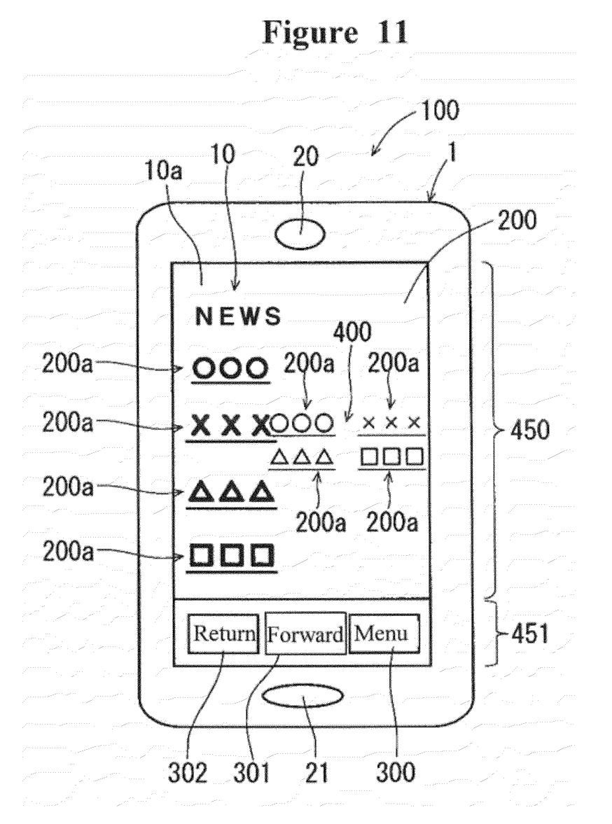

As shown in FIG. 10, the plurality of links 200a may move to the upper end of the web display region 450 to be displayed. As shown in FIG. 11, the plurality of links 200a is collectively displayed vertically in the center module in the web display region 450. The plurality of links 200a is collectively displayed horizontally in the center module of the touch panel 10a.

If the entire web page 200 cannot be displayed on the touch panel 10a due to a large web page 200, the display module 10 collectively displays the plurality of links 200a comprised in the section that is currently being displayed on the touch panel 10a in the web page 200. In this case, if the display of the web page 200 is scrolled, because the link 200a to be displayed on the touch panel 10a changes, the collective link to be displayed on the touch panel 10a changes. Even if the entire web page 200 cannot be displayed on the touch panel 10a due to a large web page 200, the display module 10 collectively displays the plurality of links 200a included in the section that is currently being displayed and links 200a comprised in the section of a web page 200 that is not currently being displayed.

As described above, because the plurality of links 200a are gathered and displayed, it becomes easy for the user to determine what kind of link 200a is included in the web page 200. Consequently, each link 200a may easily be selected by the user.

In an embodiment, the user is able to execute a collective link display by shaking the mobile phone 100; thereby, making it possible to execute the collective link display by a simple operation with respect to the mobile phone 100.

As shown in FIGS. 5, 7, 10, 11 by moving a collective link to the end of the touch panel 10a to display the collective link, it becomes easy for the user holding the mobile phone 100 in one hand to select a link 200a with the same hand. Consequently, the operation for selecting a link 200a becomes easy for the user.

In an embodiment, if the mobile phone 100 is shaken in a state inclining to the right, the collective link is moved to the right of the touch panel 10a to be displayed. If the mobile phone 100 is shaken in a state inclining to the left, the collective link is moved to the left of the touch panel 10a to be displayed. Therefore, when the user executes a collective link display, the inclining direction of the mobile phone and the location at which the collective link is displayed on the touch panel 10a are mapped. Consequently, the user is able to use the mobile phone 100 without experiencing a strange feeling in relation to the collective display-command operation and the location at which the collective link is displayed.

By shaking and inclining the mobile phone 100 to the right, it becomes easy for the user holding the mobile phone 100 in the right hand to select the link 200a with the right hand, and by shaking and inclining the mobile phone 100 to the left, it becomes easy for the user holding the mobile phone 100 in the left hand to select the link 200a with the left hand. Therefore, it might be possible to provide a mobile phone 100 that allows both right-handed users and left-handed users to easily select the link 200a. Consequently, the user may find it easy to use the mobile phone 100.

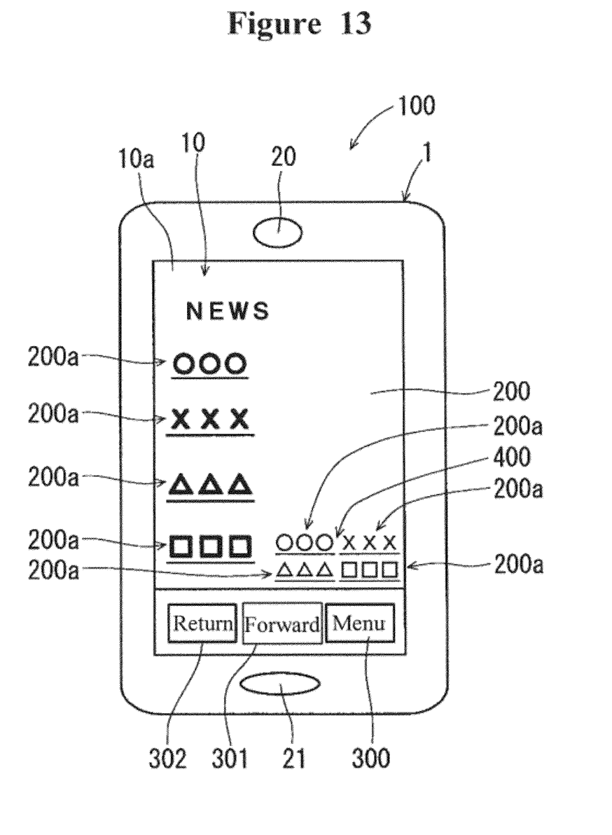

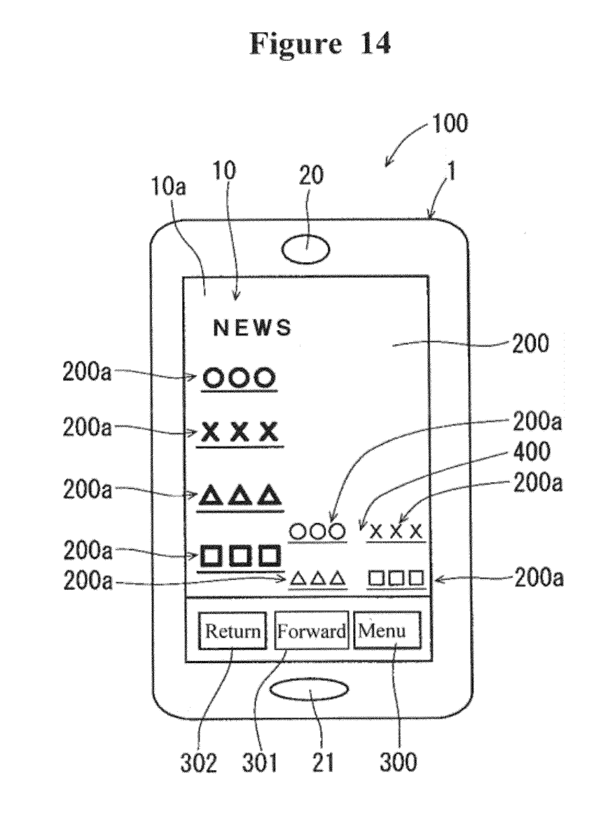

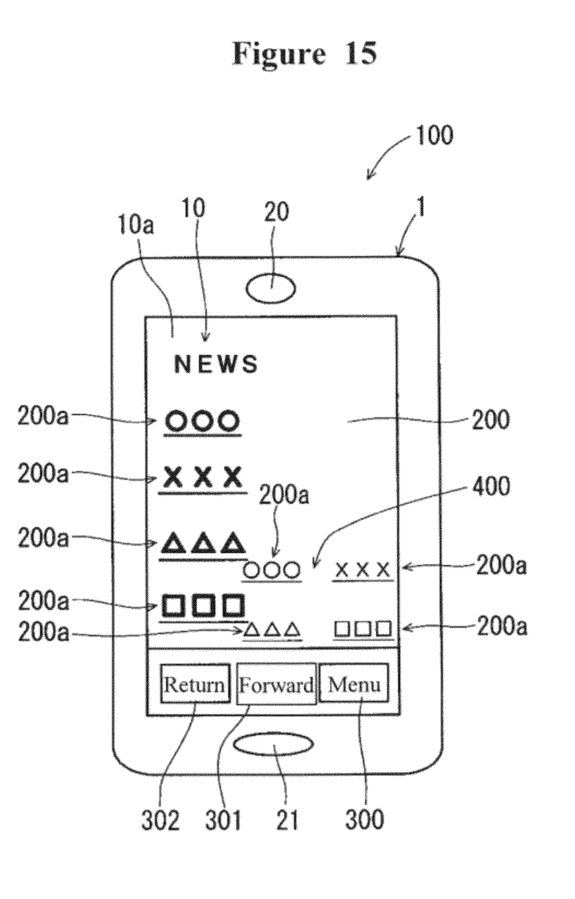

In the display module 10, in an embodiment, as a number of brisk shakes in one direction of the mobile phone 100 increases, the density of the plurality of links 200a in the collective link-display region 400; that is, the density of the collective link increases. For example, as shown in FIG. 13, the density of the collective link should be maximized in the case of briskly shaking the mobile phone 100 downwards. If the mobile phone 100 is briskly shaken twice downwards, as shown in FIG. 14, the density of the collective link is intended to be smaller than when the mobile phone 100 is shaken more than three times. If the mobile phone 100 is shaken only once downwards, as shown in FIG. 15, the density of the collective link is intended to be smaller than the case in which the mobile phone 100 is shaken twice. The number at which the density is maximum is not necessarily limited to three times. The number at which the density is maximum may be four times or five times.

Each time the mobile phone 100 is briskly shaken in one direction, the display module 10 shows a display such that each of the plurality of links 200a approaches a final position to be displayed in the collective link-display region 400. When the mobile phone 100 is being shaken, the plurality of links 200a are displayed as if said links are seen to be gradually gathering.

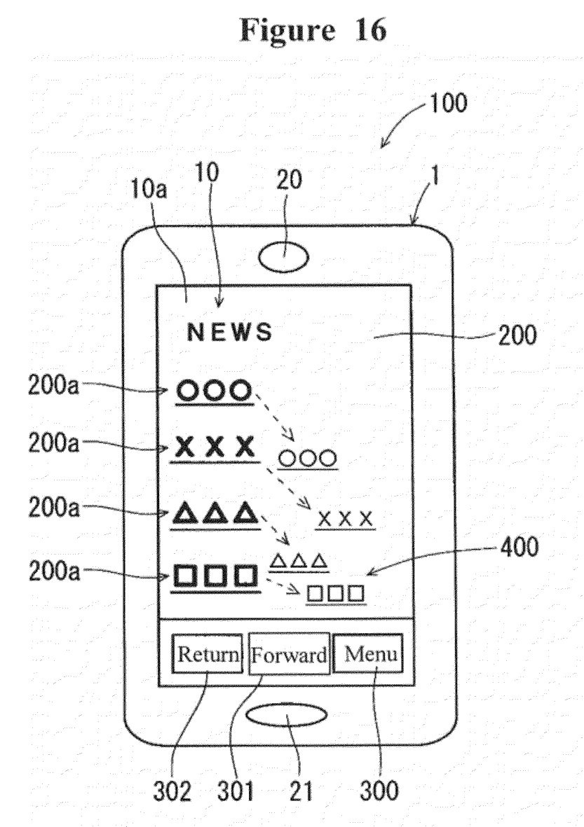

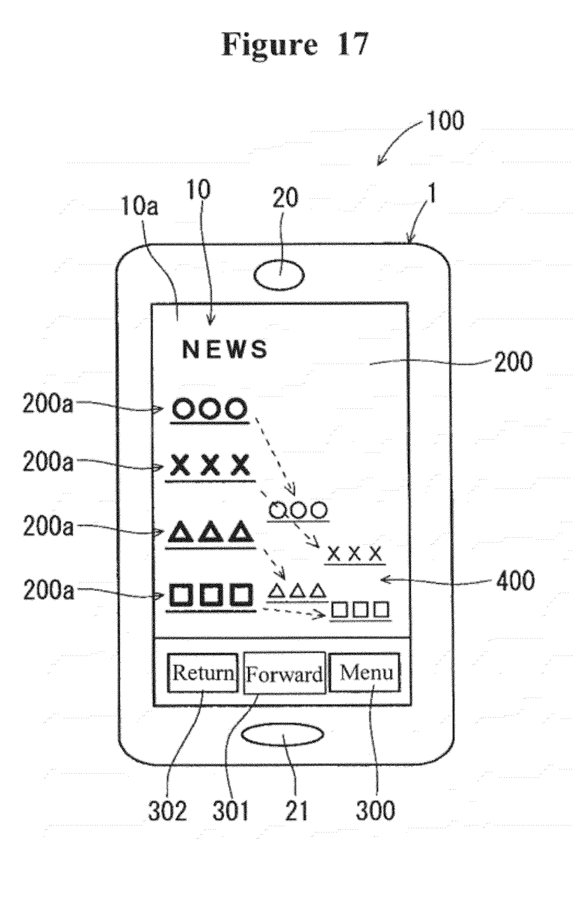

For example, a case to be considered is the case in which when the mobile phone 100 is shaken briskly three times downwards, the move of the plurality of links 200a is completed and the plurality of links 200a are displayed in the collective link-display region 400. In this case, once the mobile phone 100 is shaken briskly downwards, as shown in FIG. 16, each of the plurality of links 200a slightly approaches a final location to be displayed in the collective link-display region 400. If the mobile phone 100 is shaken briskly one more time downwards, as shown in FIG. 17, each of the plurality of links 200a further approaches the final location to be displayed in the collective link-display region 400. When the mobile phone 100 is further shaken briskly one more time downwards, as shown in FIG. 13, each of the plurality of links 200a is displayed in the final location within the collective link-display region 400.

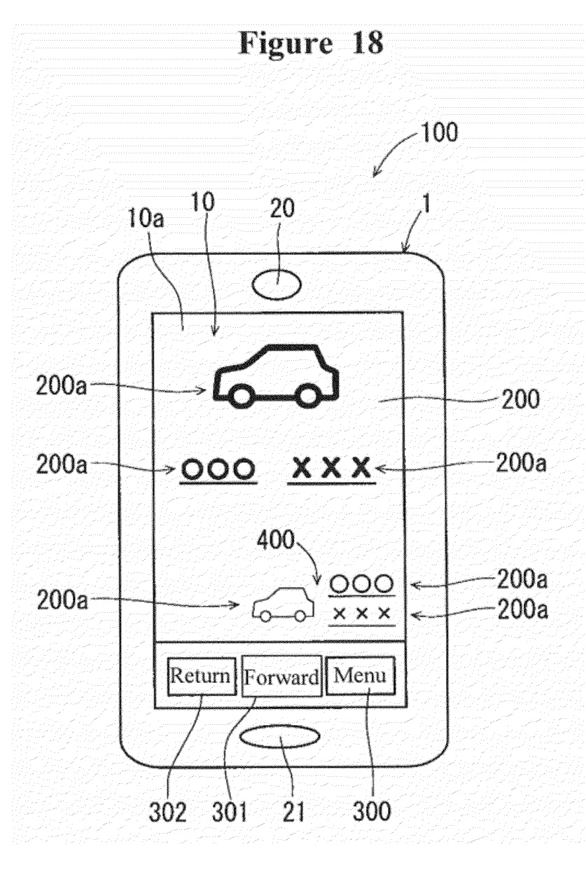

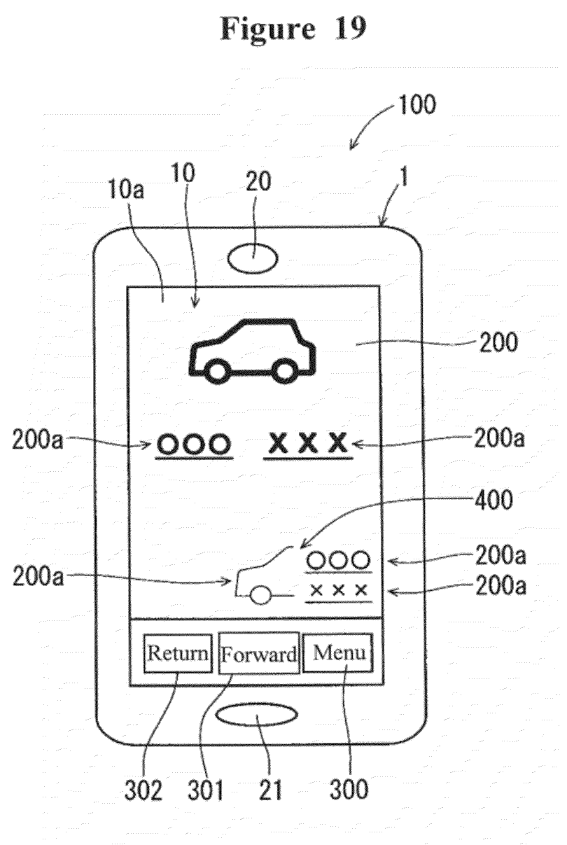

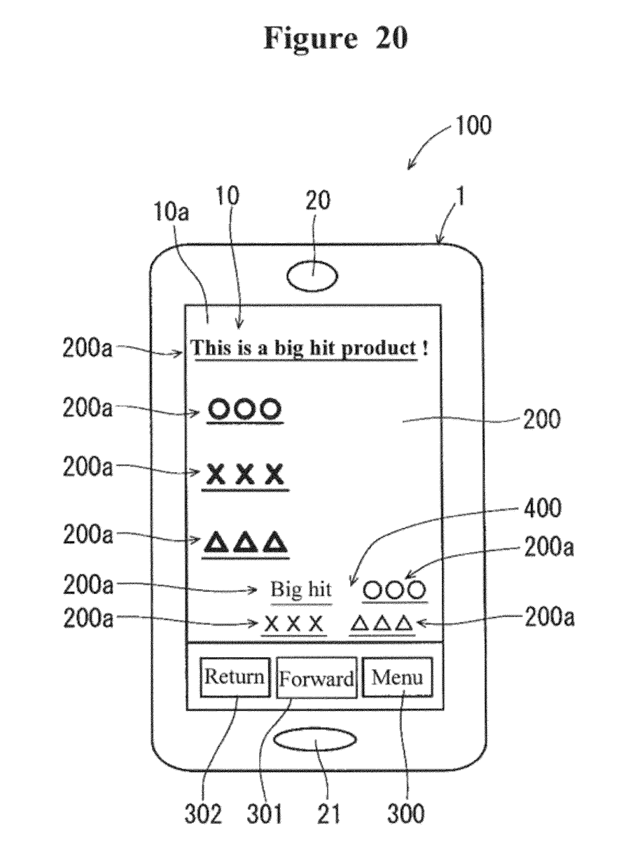

If the size of the link 200a is large, the display module 10 shrinks the link 200a and displays said link 200a in the collective link-display region 400. If the size of the link 200a is large, the display module 10 cuts out a module of the link 200a and displays said link 200a in the collective link-display region 400. FIG. 18 shows how the display module 10 shrinks the link 200a indicated by bitmap style graphics, or similar graphic, and displays the link 200a in the collective link-display region 400. The link 200a indicated by a graphic of a car is reduced in size and displayed in the collective link-display region 400. FIG. 19 shows how the display module 10 cuts out a module of the link 200a indicated by a graphic and displays said link 200 a in the collective link-display region 400. A module of the link 200a indicated by a graphic of a car is cut out and displayed in the collective link-display region 400. FIG. 20 shows how the display module 10 cuts out a module of the link 200a indicated by a long string of letters and displays said link 200a in the collective link-display region 400. “A big hit” which is a module of the link 200a indicated by a string of letters “This is a big hit product!” is cut out and displayed in the collective link-display region 400.

As described above, the collective link-display region 400 may be reduced in size by shrinking the link 200a or displaying a module of it in the collective link-display region 400.

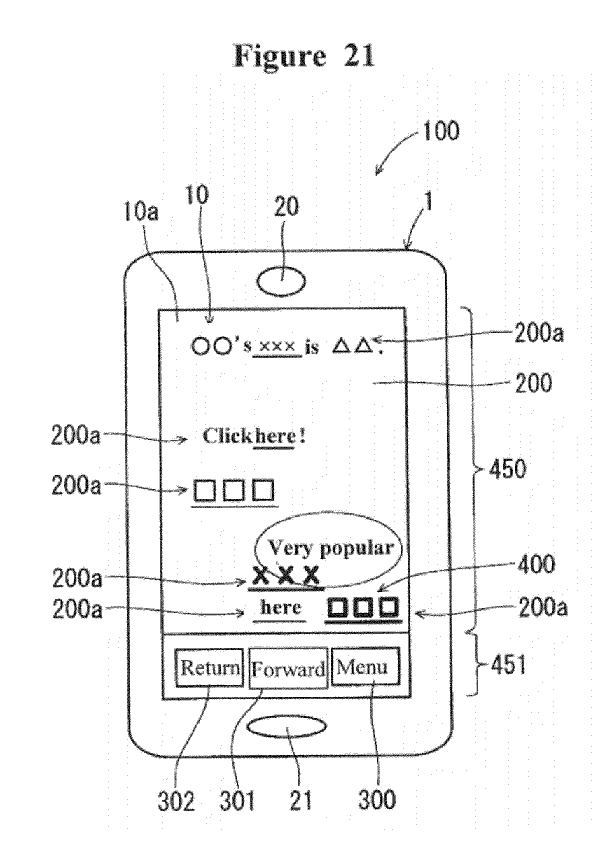

As shown in FIG. 21, a collective link is displayed such that the display density becomes higher than the web page 200. In FIG. 21, the collective link is displayed such that the display density becomes higher than the web page 200 by indicating the letters, or the like shown in the web page 200 with a thin line and indicating the collective link as a bold line.

The operation detection module 140 may comprises a first operation mode for receiving operations only with respect to the web page 200 among web page 200 and collective links, and a second operation mode for receiving operations only with respect to the collective links among the web page 200 and collective links.

If the operation detection module 140 is in the first operation mode, when the user taps a link display region of the collective link-display region 400, the operation detection module 140 switches from the first operation mode to the second operation mode. If the operation detection module 140 is in the second operation mode, when the user taps the web display region 450, the operation detection module 140 switches from the second operation mode to the first operation mode.

If the operation detection module 140 is in the first operation mode, as shown in FIG. 5, the display module 10 displays the web page 200 such that the display density becomes higher than the collective link. If the operation detection module 140 is in the second operation mode, as shown in FIG. 21, the display module 10 displays the collective link such that the display density becomes higher than the web page 200. Consequently, the user is able to easily determine whether the current mode of the operation detection module 140 is the first operation mode or the second operation mode. If the operation detection module 140 is in the first operation mode and the collective link as well as the web page 200 are displayed such that the display density of the collective link becomes lower than that of web page 200, for a section in the web page 200 overlapping the collective link, it is displayed so as to be seen through from the collective link.

The above embodiment defines a first collective display-command operation for shaking the mobile phone 100 in a state inclining to the right and a second collective display-command operation for shaking the mobile phone 100 in a state inclining to the left. However, regardless of whether the mobile phone 100 is inclined or not, the operation of shaking the mobile phone 100 may be simply regarded as a collective display-command operation. In this case, only when the mobile phone 100 is shaken briskly in a specific direction (for example downwards), is the collective link display executed.

A collective link display may be executed simply by shaking the mobile phone 100 regardless of whether said mobile phone 100 was shaken in a specific direction or not. If the operation of shaking the mobile phone 100 is a collective display-command operation, the inclining direction of the mobile phone 100 is not detected. Therefore, as in the above embodiment, sometimes changing the display location of the collective link is not possible by the inclining direction of the mobile phone 100. Consequently, the collective link may be displayed in a fixed location that is preliminarily defined.

The first collective display-command operation may be the operation to shake (regardless of the shaking direction) the mobile phone 100 when the touch panel 10a is not in a state of being pressed. The second collective display-command operation may be the operation not to shake (regardless of the shaking direction) the mobile phone 100 when the touch panel 10a is in a state of being pressed by the user.

In this case, when the operation detection module 140 detects the first collective display-command operation, the plurality of links 200a are gathered to a prescribed region on the touch panel 10a and displayed therein. For example, the plurality of links 200a are gathered in the center part (in the vicinity of the center of the touch panel 10a) horizontally or vertically and displayed on the touch panel 10a.

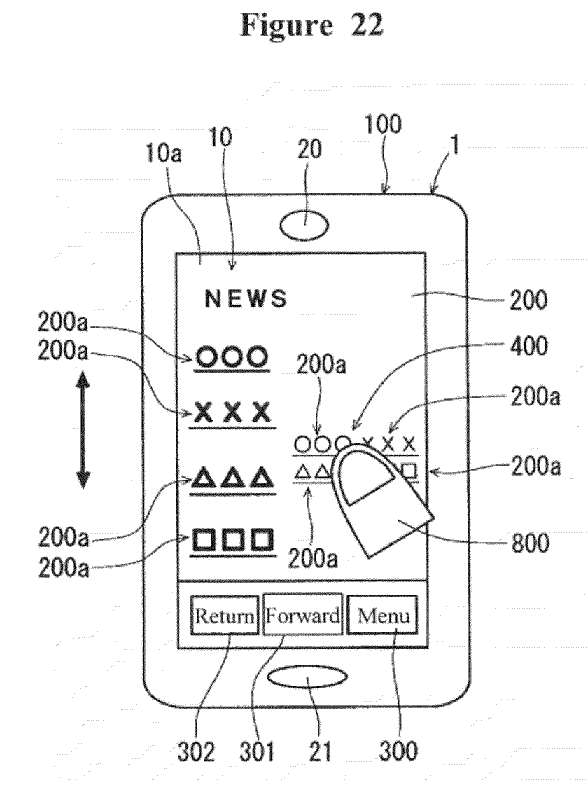

On the other hand, when the operation detection module 140 detects the second collective display-command operation, the plurality of links 200a are collectively displayed at the place pressed by the user on the touch panel 10a. The collective link-display region 400 becomes a partial region including the place pressed on the touch panel 10a. FIG. 22 shows a collective link display in the event that the operation detection module 140 detects the second collective display-command operation. The plurality of links 200a is collectively displayed at the place pressed by a finger 800 on the touch panel 10a.

As described above, the user is able to display the plurality of links 200a at a desired place on the touch panel 10a. That is, the user is able to arrange the link 200a at a place that is easy for her/him to operate as he/herself desires.

The collective display-command operation is an operation for the user to press the touch panel 10a longer than a prescribed interval regardless of whether the mobile phone 100 is or is not in a state being shaken. When the operation detection module 140 detects the collective display-command operation, the plurality of links 200a are collectively displayed at the pressed location on the touch panel 10a as in the display example of FIG. 22. The user is able to collectively display the plurality of links 200a at a place that is easy for her/him to operate as she/he desires.

Regardless of whether the mobile phone 100 is being shaken or not, the collective display-command operation includes a movement in a contact state with a finger with respect to the touch panel 10a. When the operation detection module 140 detects the collective display-command operation, the plurality of links 200a are collectively displayed at the place where movement of the finger discontinued on the touch panel 10a.

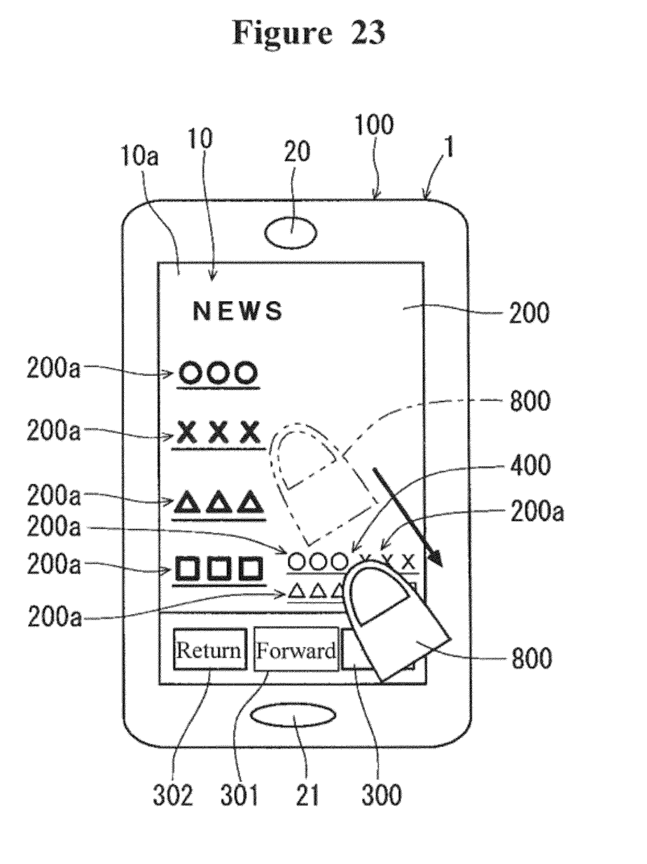

That is, the collective link-display region 400 becomes a partial region including the place where movement of the finger discontinued on the touch panel 10a. FIG. 23 shows a collective link display in the present example. Even in such a case, the user is able to collectively display the plurality of links 200a in a place that is easy for her/him to operate as she/he desires. The place where the movement of the finger discontinued is the place where movement of the finger has stopped or the place where the finger has moved away from the touch panel 10a.

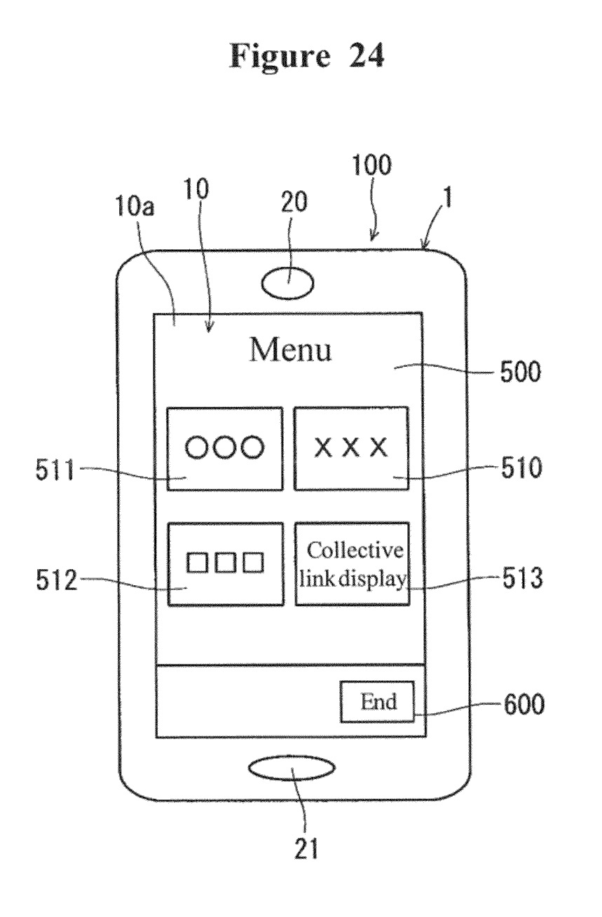

As for the collective display-command operation, an operation with respect to operation buttons included on the menu screen for setting a collective link display is regarded as a collective display-command operation. FIG. 24 shows an example in which a menu screen 500 is being displayed on the touch panel 10a. When the operation button 300 described above indicated at the lower end of the touch panel 10a where the web page 200 is being displayed is tapped, the display shows the menu screen 500 on the touch panel 10a.

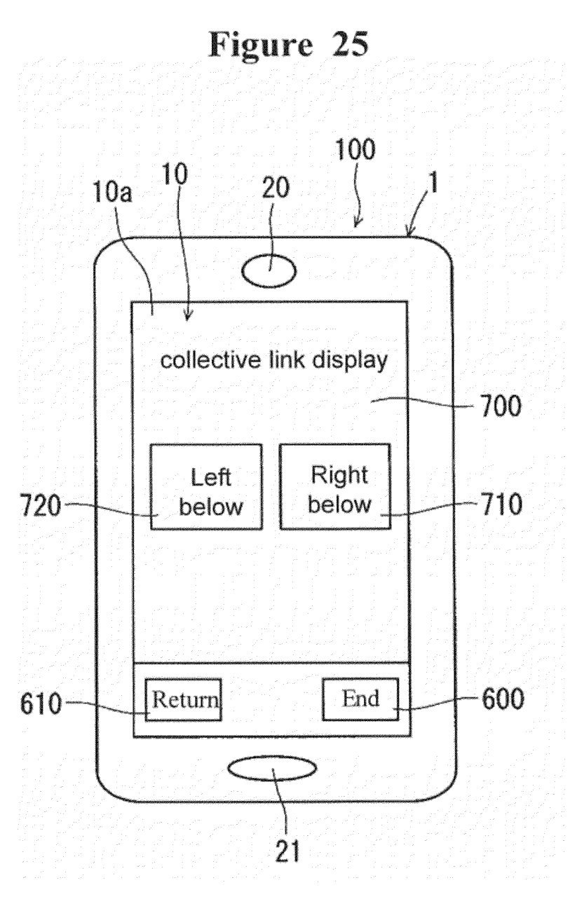

As shown in FIG. 24, the menu screen 500 includes a plurality of operation buttons 510 to 513. At the lower end of the touch panel 10a for displaying the menu screen 500, an operation button 600 to return to a screen for displaying the web page 200 is shown. The operation button 513 is for setting a collective link display. When the operation button 513 is tapped by the user, a sub-menu screen 700 as in FIG. 25 is displayed on the touch panel 10a.

On the sub-menu screen 700 shown in FIG. 25, an operation button 710 and an operation button 720 are shown. The operation button 710 moves the plurality of links 200a to the right of the touch panel 10a so as to be displayed. The operation button 720 moves said links 200a to the left of the touch panel 10a so as to be displayed. An operation button 600 and an operation button 610 are displayed below the sub-menu screen 700. The operation button 610 returns the display of the touch panel 10a to a previous display that is one before the current display.

When the operation button 710 is tapped, as shown in FIG. 5, the plurality of links 200 are moved to the right of the touch panel 10a and displayed therein.

When the operation button 720 is tapped, as shown in FIG. 7, the plurality of links 200 are moved to the left of the touch panel 10a and displayed therein.

In FIG. 24, when the operation button 513 of the menu screen 500 is operated, the plurality of links 200a are gathered to a fixed region that has been preliminarily determined, and displayed on the touch panel 10a without any display.

After the link 200a is selected, the web page 200 indicated by the link 200a is brought up so as to be in normal display. That is, when the web page 200 indicated by the selected link 200a is displayed, the collective link display is cancelled. However, the collective link display may also be cancelled as a result of briskly shaking the mobile phone 100 in the direction opposite to the direction in which the mobile phone 100 was briskly shaken in the event of executing the collective link display. Such a cancellation method of the collective link display is described below.

As in FIG. 5, for the case in which the plurality of links 200a are displayed as a result of having been moved to the right of the touch panel 10a via detection of the first collective-command operation by the operation detection module 140, when the operation detection module 140 detects an operation of briskly shaking the mobile phone 100 upwards in a state inclining to the right, the display module 10 cancels the collective link display and brings up the web page 200 so as to be in normal display. Regardless of the inclination of the mobile phone 100, if the mobile phone 100 is briskly shaken upwards, the collective link display is cancelled.

For the case in which the plurality of links 200a shown in FIG. 7 are displayed as a result of having been moved to the left of the touch panel 10a via detection of the second collective-command operation by the operation detection module 140, when the operation detection module 140 detects an operation of briskly shaking the mobile phone 100 upwards in a state inclining to the right, the display module 10 cancels the collective link display and brings up the web page 200 so as to be in normal display. Regardless of the inclination of the mobile phone 100, if the mobile phone 100 is briskly shaken upwards, the collective link display is cancelled.

As described above, the user is able to cancel the collective link display by briskly shaking the mobile phone 100 in a direction that is opposite the direction in which the mobile phone 100 was briskly shaken in the event of executing the collective link display. In this manner, the collectively displayed links on the display screen can be cancelled, when the operation is detected, wherein the operation comprises moving the mobile phone 100 in one direction.

The cancellation of the collective link display may also be carried out when the display of the web page 200 on the touch panel 10a is scrolled. When flicking upwards or downwards with respect to the collective link-display region 400 detected by the operation detection module 140, the display of the web page 200 is scrolled. Then, the display module 10 cancels the collective link display. In the web display region 450, even in the event of detecting upwards or downwards flicking at the operation detection module 140 with respect to a region other than the collective link-display region 400, the display of the web page 200 is scrolled; thereby, the display module 10 also cancels the collective link display at this time.

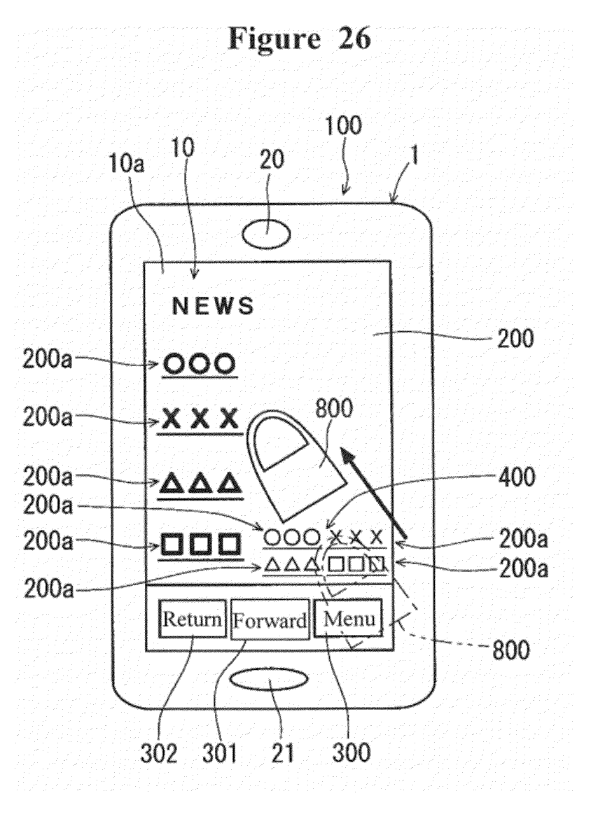

As shown in FIG. 26, the cancellation of the collective link display may also be executed when the operation detection module 140 detects an operation (first additional operation) to move from the collective link-display region 400 to the outside thereof while the finger 800 is in contact with the touch panel 10a.

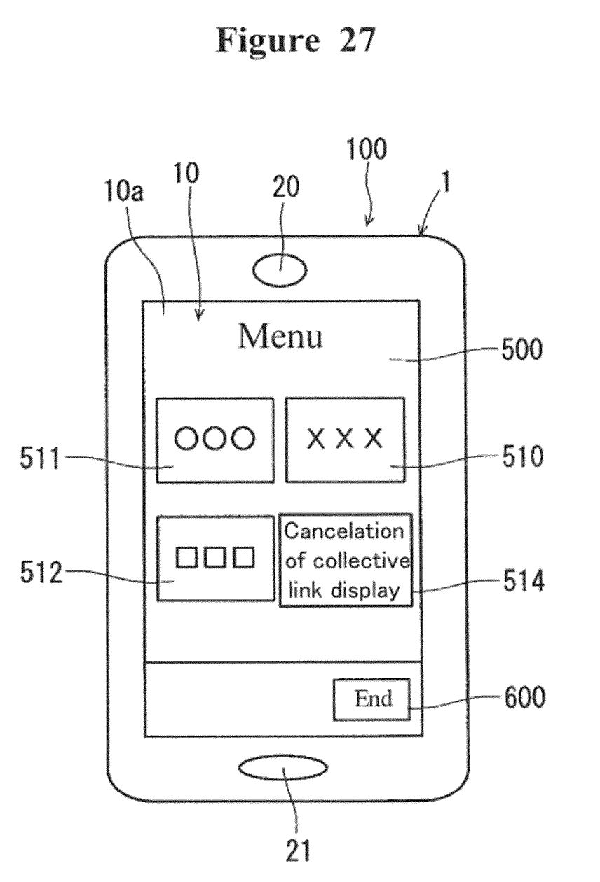

The cancellation of the collective link display may also be executed using the menu screen 500. FIG. 27 shows the menu screen 500 in the event of cancelling the collective link display using the menu screen 500. While the display 10 is engaged in the collective link display, if the operation button 300 shown in the lower end of the touch panel 10a is tapped by the user, the menu screen 500 appears. The operation button 514 for cancelling the collective link display is shown on the menu screen 500 shown in FIG. 27. When the operation detection module 140 detects tapping with respect to the operation button 514, as shown in FIG. 14 or the like, the collective link display of the touch panel 10a is cancelled and the web page 200 is brought up so as to be in normal display.

When the user selects the link 200a, the web page 200 indicated by the selected link 200a is displayed and, at the same time, the plurality of links 200a are brought to be in the collective link display. Consequently, when the web page 200 indicated by the selected link 200a is displayed, the user does not have to execute a collective command operation for the collective link display with regard to the web page

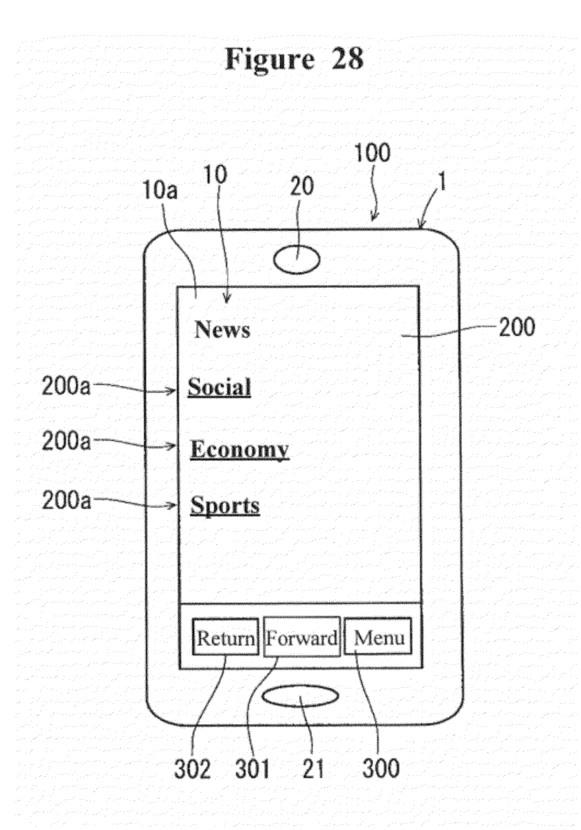

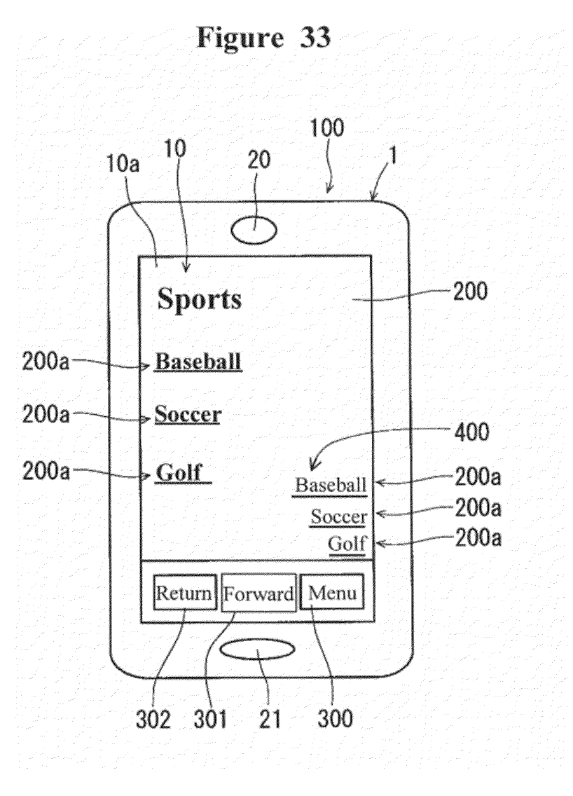

If the web page 200 when the collective display-command operation is detected and the collective link display is executed is regarded as an initial page 200, when another web page 200 (third web page) is displayed instead of the initial page 200 (first web page), the display module 10 may display a link 200a indicating the initial page 200 and a link 200a (second single link) comprised together in the initial page 200. FIGS. 28 to 33 are drawings explaining the above operations.

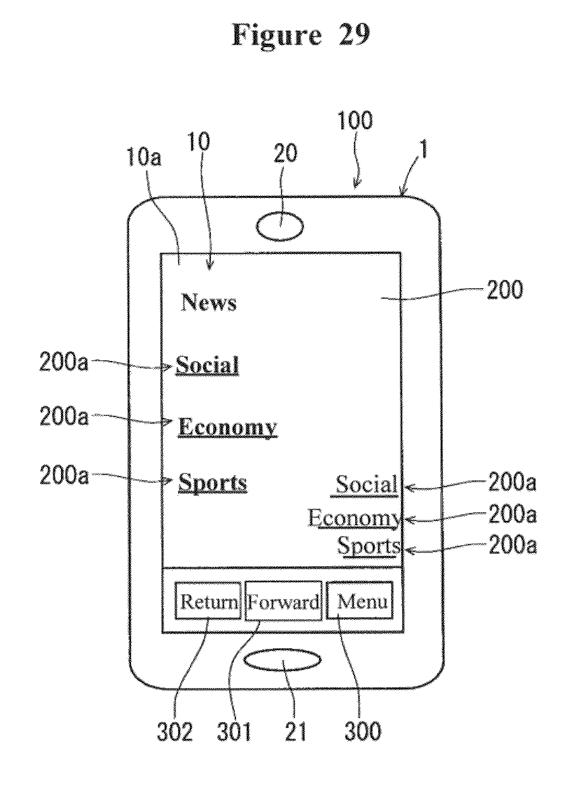

When the web page 200 shown in FIG. 28 is displayed on the touch panel 10a, if the operation detection module 140 detects the collective display-command operation (for example, first collective display-command operation), the display control module 130 sets the web page 200 as an initial page 200. As shown in FIG. 29, next, the display control module 130 causes the display module 10 to execute the collective link display with regard to the web page 200.

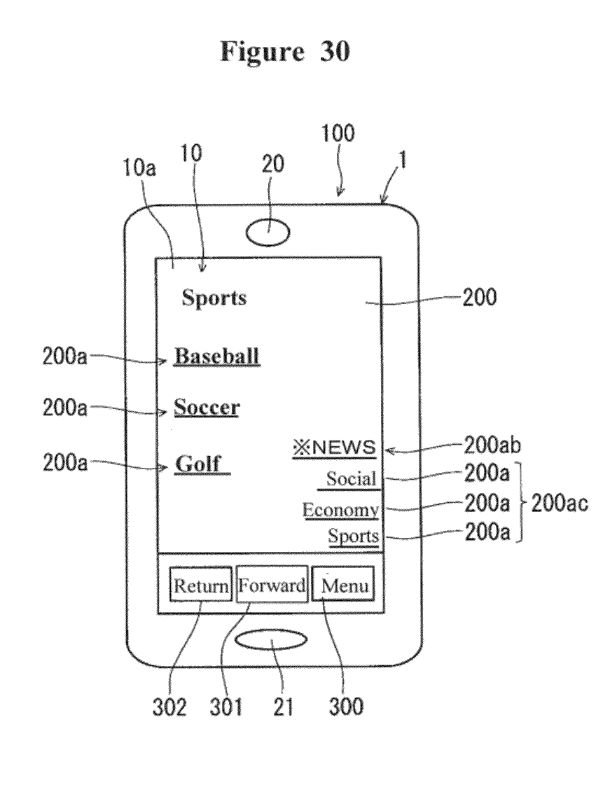

In the collective link of FIG. 29, when a link 200a indicated by “sports” is selected, the display module 10 displays the web page 200 indicated by the selected link 200a on the touch panel 10a. Then, a link 200ab (hereinafter, sometimes referred to as “initial page link 200ab”) indicating the initial page 200 and a collective link (hereinafter, sometimes referred to as “initial collective link 200ac”) displayed with the initial page 200 are displayed together on the touch panel 10a. The initial page link 200ab is displayed above the initial collective link 200ac in FIG. 30. In order for the user to specify the initial page link 200ab easily, “” is indicated as an identification symbol at the head section of the initial page link 200ab. The identification symbol specifying the initial page link 200ab does not necessarily have to be displayed.

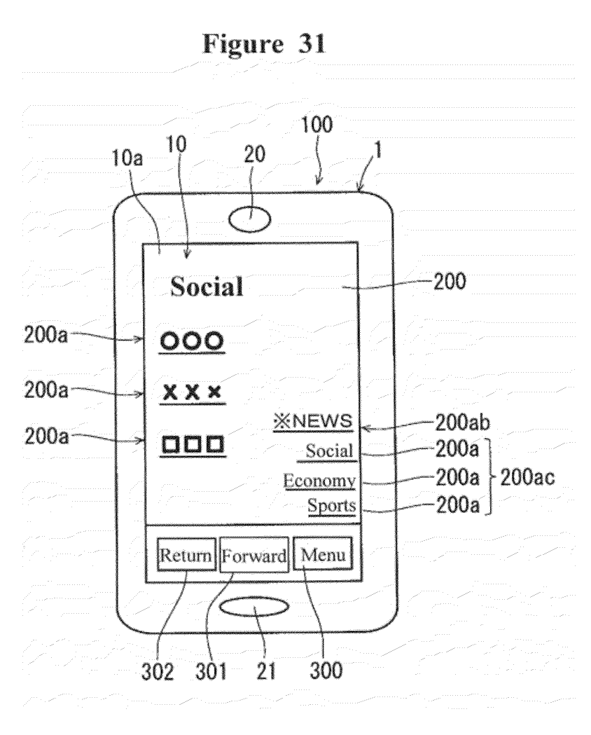

In FIG. 30, when a link 200a indicated by “social” is selected in the initial collective link 200ac, the display module 10 displays the web page 200 indicated by the selected link 200a in touch panel 10a. In FIG. 31, the initial page link 200ab and the initial collective link 200ac are arranged and displayed together on the touch panel 10a.

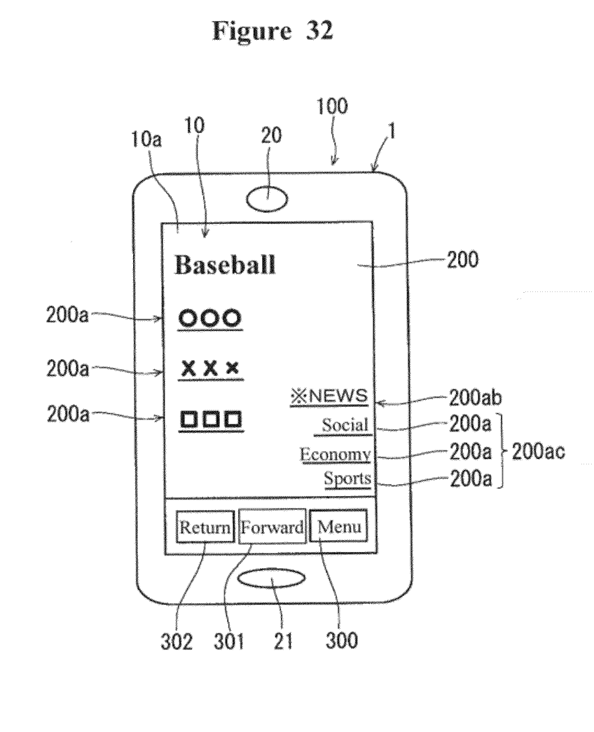

If a link 200a indicated by “baseball” is selected in FIG. 30, a web page 200 indicated by the selected link 200a is displayed on the touch panel 10a. In FIG. 32, the initial page link 200ab and the initial collective link 200ac are arranged and displayed together.

When a web page 200 other than the initial page 200 is displayed on the touch panel 10a, if the operation detection module 140 detects the collective display-command operation, the display module 10 may cancel the display of the initial page link 200ab as well as the initial collective link 200ac. In this case, the display module 10 collectively displays the plurality of links 200a that are being displayed. For example, when the display of the touch panel 10a is as in FIG. 30, and if the operation detection module 140 detects the first collective display-command operation, the display of the initial page link 200ab as well as the initial collective link 200ac are cancelled on the touch panel 10a. Then, the web page 200 currently displayed is brought up to be in the collective link display. Subsequently, the web page 200 is set as a new initial page 200. Thereafter, the mobile phone 100 operates likewise.

In FIG. 30 to FIG. 34, the initial page link 200ab and the initial collective link 200ac are both displayed, but it is also possible to display only one of either the initial page link 200ab or the initial collective link 200ac.

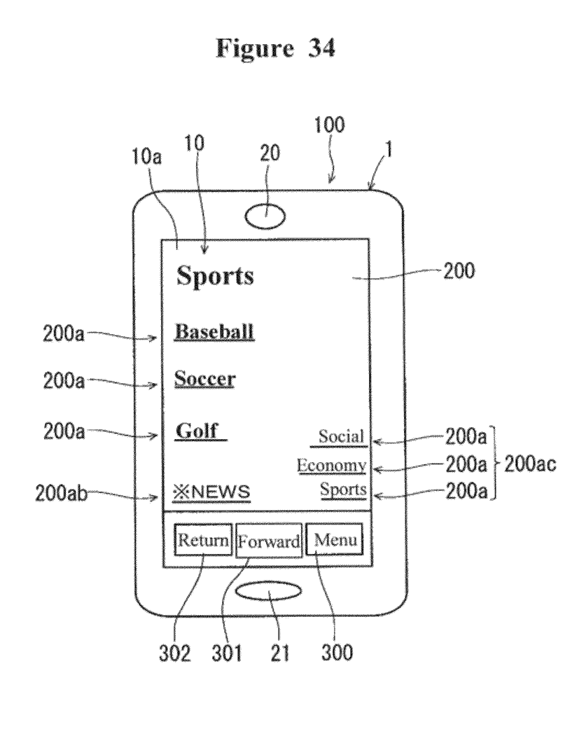

In the FIG. 34, the display module 10 may display the initial page link 200ab and the initial collective link 200ac separately from each other to a certain extent. In FIG. 34, the initial page link 200ab is moved to the left of the touch panel 10a and displayed therein, while the initial collective link 200ac is moved to the right of the touch panel 10a and displayed therein. In this case, an identification symbol for specifying the initial page link 200ab does not necessarily have to be displayed.

In the event of displaying the initial collective link 200ac with the mobile phone 100, the link 200a indicating the currently displayed web page 200 does not have to be displayed among the plurality of links 200a comprised in the initial collective link 200ac. For example, in the display example of FIG. 30, the link 200a indicated by “sports” that is included in the initial collective link 200ac is not displayed.

As described above, because the link (initial web page link) 200ab indicating the initial page of the web page 200 (initial page 200) that was subjected to collective link display is displayed on the touch panel 10a when the initial page of the web page 200 is no longer displayed, the user is able to easily display the initial page of the web page 200 again. For example, if the initial page of the web page 200 is set for the web page 200 on which a list of news pieces is shown, after the user watches the individual piece of news, the web page 200 on which the list of news pieces is shown is displayed. If the initial page of the web page 200 is set for the web page (search result page) 200 on which the list of search results are shown, after the user watches individual web page shown in the list of search results, the list of search results is displayed.

Instead of the initial page 200, when another web page 200 is displayed, by displaying the plurality of links 200a comprised in the initial page 200, even after the initial page 200 is no longer displayed, the user is able to easily select a link 200a that was included on the initial page 200. If the initial page 200 is set to be the web page 200 on which the list of news pieces is shown, the user is able to watch another piece of news soon after one piece of news is watched. If the initial page 200 is set to be the web page 200 on which the list of search results is shown, the user is able to see another web page included in the list of search results soon after seeing a web page that is included in the list of search results.

In the above embodiment, if the mobile phone 100 is moved in a prescribed direction by the user due to the case body operation-determination module 132, the display module 10 may also execute the collective link display.

In the above embodiment, a case of applying the present invention comprising one display screen was described, but the present invention is also applicable to a mobile phone comprising two display screens. For example, the present invention is applicable to a sliding mobile phone in which the upper side of the case body comprising a first display module that includes a first touch panel is slidable over the lower side of the case body comprising a second display module that includes a second touch panel.

In this case, when a state in which the first display module is displaying a web page while the second display module is not visibly recognized as the upper side of the case body and the lower side of the case body are overlapped, changes in the state in which the second display module becomes visibly recognized when the upper side case slides, making it possible to collectively display a plurality of links included on the web page that is being displayed on the first display module together on the second display module.

When the state in which the first display module is displaying a web page and the second display module is not visibly recognized as the upper side case and the lower side of the case body are overlapped, changes in the state in which the second display module becomes visibly recognized when the upper side of the case body slides, making it possible to display the web page using both the first as well as the second display modules and, at the same time, the plurality of links included in the web page may collectively be displayed either on the first display module or the second display module. In this event, the plurality of gathered links (collective links) is displayed in an overlapping manner with the web page.

In this document, the terms “computer program product”, “computer-readable medium”, and the like may be used generally to refer to media such as, for example, memory, storage devices, or storage unit. These and other forms of computer-readable media may be involved in storing one or more instructions for use by the CPU 30a to perform specified operations. Such instructions, generally referred to as “computer program code” or “program code” (which may be grouped in the form of computer programs or other groupings), when executed, enable the data sorting method of the mobile phone 100.

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. An electronic device comprising:
a touch panel comprising a display screen operable to display a first web page comprising a first plurality of links;
an operation detection module operable to detect an operation by a user; and
a control module operable to display the first links in a first region of the display screen as a first collective link display, when the operation is detected.

2. The electronic device according to claim 1, wherein the control module is further operable to move the first links in one direction and display the first links thereon, wherein the one direction comprises one of a right and a left of the display screen.

3. The electronic device according to claim 1, wherein the control module is further operable to cancel the collective link display, when the operation is detected and the operation comprises moving the electronic device in one direction.

4. The electronic device according to claim 1, wherein the control module is further operable to display the first links at a location on the display screen that was pressed, when the operation is detected and the operation comprises moving the electronic device while the location is being pressed.

5. The electronic device according to claim 1, wherein the control module is further operable to display the first links at a location at which a finger discontinued movement on the display screen, when the operation is detected and the operation comprises the finger moving while in contact with the display screen.

6. The electronic device according to claim 1, wherein the control module is further operable to collectively display the first links at a location that is being pressed on the display screen, when the operation is detected and the operation comprises the display screen pressed longer than a prescribed interval.

7. The electronic device according to claim 1, wherein the control module is further operable to cancel the first collective link display, when a first additional operation is detected and the first additional operation comprises a finger moving while in contact with the display screen from a second region located outside the first region.

8. The electronic device according to claim 1, wherein the control module is further operable to scroll the display of the first web page, when a second additional operation is detected and the second additional operation comprises a prescribed operation with respect to the first region.

9. The electronic device according to claim 1, wherein the control module is further operable to collectively display a second plurality of links associated with a second web page together with the second web page on the display screen, when the operation is detected and the operation comprises selection of a first single link displayed on the first region and the second web page is displayed on the display screen.

10. The electronic device according to claim 1, wherein the control module is further operable to collectively display a second single link indicating the first web page together with a third web page, when the operation is detected and the operation comprises displaying the third web page instead of displaying the first web page.

11. The electronic device according to claim 10, wherein the control module is further operable to cancel the second single link indicating the first web page from the display screen, when a third additional operation is detected and the second single link indicating the first web page is being displayed on the display screen together with the third web page.

12. The electronic device according to claim 11, wherein the control module is further operable to gather a third plurality of links comprised in the third web page and display the third links on the display screen.

13. The electronic device according to claim 10, wherein the control module is further operable to display the first links comprised in the first web page together with the third web page, when the third web page is displayed instead of the first web page.

14. The electronic device according to claim 13, wherein the control module is further operable to cancel the first links comprised in the first web page from the display screen, when a fourth additional operation is detected and the first links comprised in the first web page are being displayed together with the third web page.

15. An electronic device display control method, comprising
displaying a web page comprising a plurality of links on a display screen of a touch panel;
detecting an operation on the touch panel; and
collectively displaying the links on a first region of the display screen, when the operation is detected while the web page is displayed on the touch panel.

16. The method according to claim 15, further comprising cancelling collectively displaying the links on the display screen when the operation is detected, wherein the operation comprises moving the electronic device in one direction.

17. The method according to claim 15, further comprising displaying the links at a location on the display screen that was pressed, wherein the operation comprises moving the electronic device while the location is pressed.

18. The method according to claim 15, further comprising displaying the links at a location at which a finger discontinued movement on the display screen on the display screen that was pressed, wherein the operation comprises the finger moving while in contact with the display screen.

19. The method according to claim 15, further comprising collectively displaying the links at a location that is being pressed on the display screen, wherein the operation comprises the display screen pressed longer than a prescribed interval.

20. The method according to claim 15, further comprising canceling collectively displaying the links, when the operation is detected and the operation comprises a finger moving while in contact with the display screen from a second region to outside the first region.
